(19) United States
(12) Patent Application Publication
(10) Pub. No.: US 2023/0120024 A1
(43) Pub. Date: Apr. 20, 2023

(54) WIRELESS COMMUNICATION METHOD WITH DYNAMIC RADIO CHAIN SWITCHING MECHANISM

(71) Applicant: MEDIATEK INC., Hsin-Chu (TW)

(72) Inventors: Cheng-Yi Chang, Hsinchu City (TW); Meng-Hsiang Lai, Hsinchu City (TW); Xingbo Zhao, Shenzhen City (CN)

(73) Assignee: MEDIATEK INC., Hsin-Chu (TW)

(21) Appl. No.: 17/963,203

(22) Filed: Oct. 11, 2022

Related U.S. Application Data
(60) Provisional application No. 63/255,453, filed on Oct. 14, 2021.

(30) Foreign Application Priority Data
Aug. 26, 2022 (CN) 202211031761.4

(51) Int. Cl. H04B 7/06; H04W 76/15

(52) U.S. Cl. CPC H04B 7/0686; H04W 76/15; H04W 88/10

(57) ABSTRACT

The present invention provides a wireless communication method performed by an AP, wherein the AP is an NSTR AP MLD, and the wireless communication method includes the steps of: establishing a primary link and an non-primary link with a first MLD; during a first period, transmitting data to the first MLD or receiving data from the first MLD via the primary link and the non-primary link; and during a second period following the first period, in response to a channel used by the non-primary link being busy, performing a dynamic radio chain switching mechanism to adjust an antenna configuration of the primary link, and using the primary link to communicate with the first MLD.

### CROSS REFERENCE TO RELATED APPLICATIONS

This application claims the benefit of U.S. Provisional Application No. 63/255,453, filed on Oct. 14, 2021. The content of the application is incorporated herein by reference.

### BACKGROUND

IEEE 802.11be defines multiple link operations that allow an access point (AP) and a station to communicate with each other by using two or more links. Due to a hardware limitation such as spacing between antennas within the station, the AP/station can be operated in a synchronous mode or an asynchronous mode. The synchronous mode is also named as a non-simultaneous transmit and receive (NSTR) mode, that is the AP/station cannot transmit and receive data at the same time via multiple links. The asynchronous mode is also named as a simultaneous transmit and receive (STR) mode, that is the AP/station can transmit and receive data at the same time via multiple links, but the AP/station does not need to transmit data by using the multiple links simultaneously.

When the multiple link of the AP uses channels belonging to a 5 GHz band (e.g., 4.915 GHz-5.825 GHz) and/or a 6 GHz band (e.g., 5.925 GHz-7.125 GHz), the AP supporting the STR mode may induce significant manufacturing cost. Therefore, how to design an AP with low cost and high performance is an important topic.

### SUMMARY

It is therefore an objective of the present invention to provide an AP with NSTR, which has dynamic radio chain switching mechanism to improve performance, to solve the above-mentioned problems.

According to one embodiment of the present invention, a wireless communication method performed by an AP is disclosed, wherein the AP is an NSTR AP MLD, and the wireless communication method comprises the steps of: establishing a primary link and an non-primary link with a first MLD; during a first period, transmitting data to the first MLD or receiving data from the first MLD via the primary link and the non-primary link; and during a second period following the first period, in response to a channel used by the non-primary link being busy, performing a dynamic radio chain switching mechanism to adjust an antenna configuration of the primary link, and using the primary link to communicate with the first MLD.

According to one embodiment of the present invention, an AP is disclosed, wherein the AP is an NSTR AP MLD, and the AP comprises a receive circuit, a transmit circuit and a control circuit. The control circuit is configured to control the receive circuit and the transmit circuit to perform the steps of: establishing a primary link and an non-primary link with a first MLD; during a first period, transmitting data to the first MLD or receiving data from the first MLD via the primary link and the non-primary link; and during a second period following the first period, in response to a channel used by the non-primary link being busy, performing a dynamic radio chain switching mechanism to adjust an antenna configuration of the primary link, and using the primary link to communicate with the first MLD.

According to one embodiment of the present invention, a wireless communication method performed by a MLD comprises the steps of: establishing a primary link and an non-primary link with an AP; during a first period, transmitting data to the AP or receiving data from the AP via the primary link and the non-primary link; and during a second period, in response to the AP being receiving data from a wireless device via only the primary link or a channel used by the primary link being busy, transmitting data to the AP via the non-primary link.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless fidelity (Wi-Fi) communication system according to an embodiment of the present invention.

FIG. 2 is a timing diagram of an AP communicating with an NSTR MLD and a station according to one embodiment of the present invention.

FIG. 3 is a timing diagram of an AP communicating with a STR MLD and a station according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

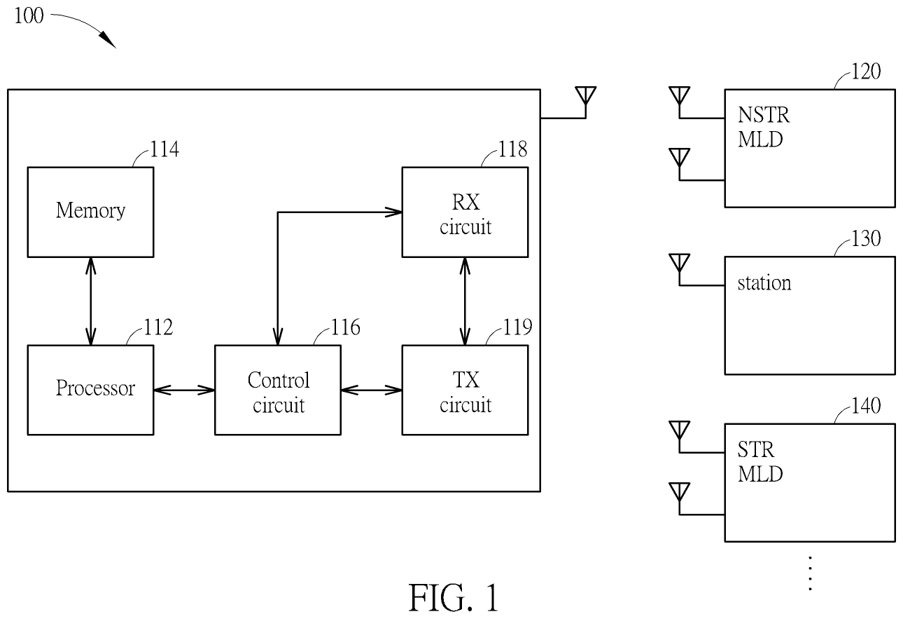

FIG. 1 is a diagram illustrating a wireless fidelity (Wi-Fi) communication system 100 according to an embodiment of the present invention. The Wi-Fi communication system has an access point (AP) 110 and a plurality of non-AP wireless devices. In the embodiment shown in FIG. 1, the AP 110 is an NSTR AP multi-link device (MLD), and the plurality of non-AP wireless devices comprise at least one of an NSTR MLD 120, an station 130 and a STRMLD 140. By way of example, but not limitation, the AP 110, the NSTR MLD 120 and the STR MLD 140 maybe in compliance with IEEE 802.11be standard. In this embodiment, because the AP 110 is the NSTR AP MLD, the AP 110 cannot transmit and receive data at the same time via multiple links. Similarly, the NSTR MLD 120 cannot transmit and receive data at the same time via multiple links either. In addition, the STR MLD 140 can transmit and receive data at the same time via multiple links.

As shown in FIG. 1, the AP 110 includes a processor 112, a memory 114, a control circuit 116, a receive (RX) circuit 118, a transmit (TX) circuit 119, and multiple antennas. The memory 114 is arranged to store a program code. The processor 112 is arranged to load and execute the program code to manage the AP 110. The control circuit 116 is arranged to control wireless communications with the NSTR MLD 120, the NSTR station 130 and/or the STR MLD 140 via the RX circuit 118 and the TX circuit 119.

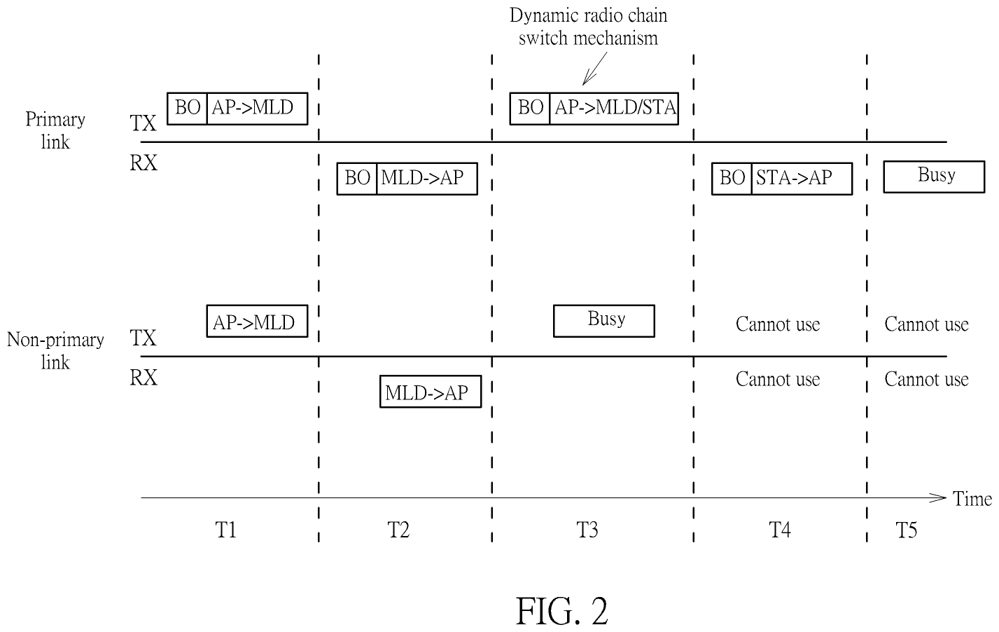

FIG. 2 is a timing diagram of the AP 110 communicating with the NSTR MLD 120 and the station 130 according to one embodiment of the present invention. Referring to FIG. 1 and FIG. 2 together, initially, the NSTR MLD 120 establishes a link with the AP 110, wherein there are two links (primary link and non-primary link) between the AP 110 and the NSTR MLD 120, that is the AP 110 can transmit data to the NSTR MLD 120 via two links simultaneously, and the AP 110 can receive data from the NSTR MLD 120 via two links simultaneously. In addition, assuming that the station 130 does not support multi-link communications, the AP 110 communicates with the station 130 via only one link (i.e., primary link). In this embodiment, the primary link is configured to use one channel of a 5 GHz band (e.g., 4.915 GHz-5.825 GHz) and a 6 GHz band (e.g., 5.925 GHz-7.125 GHz) and two antennas, and the non-primary link is configured to use another channel of the 5 GHz band and the 6 GHz band and other two antennas.

During a period T1 shown in FIG. 2, after a backoff time (the symbol “BO” in FIG. 2), the AP 110 starts to transmit data to the NSTR MLD 120 via the primary link and the non-primary link, and the start times and end times of the data transmission of the two links are preferred to be aligned.

During a period T2 immediately following the period T1, after a backoff time, the NSTR MLD 120 starts to transmit data via the primary link and the non-primary link, and the AP 110 receives the data via the two links, wherein the start times and end times of the data reception of the two links are preferred to be aligned.

During a period T3 immediately following the period T2, the AP 110 detects that the channel used by the non-primary link is currently busy, or the AP 110 is notified by another device that the channel used by the non-primary link is currently busy, that is the channel may be occupied by another basic service set (BSS). At this time, the AP 110 notifies the NSTR MLD 120 and/or the station 130 that only the primary link is used for data transmission/reception, and the AP 110 handshakes the capability (such as support multi-link communication or not) with the NSTR MLD 120 and/or the station 130 to perform a dynamic radio chain switching mechanism to switch the antenna configuration of the primary link, so that the primary link corresponds to more antennas for data transmission/reception. In this embodiment, the control circuit 116 can configure the primary link to use three antennas or four antennas, and the non-primary link is not used for data transmission/reception now. In the period T3, because the primary link is configured to use more antennas, the AP 110 can transmit data to the NSTR MLD 120 and/or the station 130 with higher performance.

During a period T4 immediately following the period T3, due to the reconfiguration of the antennas in the period T3, after the backoff time, the station 130 transmits data via the primary link with more antennas, and the AP 110 receives the data via the primary link only. At this time, the non-primary link cannot be used for data transmission/reception by the AP 110. In one embodiment, the antenna switching configuration can be implemented by protocol-based mechanism (e.g., with RTS (request to send) or MU-RTS (multi user request to send) as initial control PPDU (physical layer protocol data unit)) or protocol-less mechanism (i.e., the antenna is switched after SIG is decoded.)

During a period T5 immediately following the period T4, the AP 110 detects that the channel used by the primary link is currently busy, or the AP 110 is notified by another device that the channel used by the primary link is currently busy, that is the channel may be occupied by another BSS. At this time, the primary link is not used for data transmission/reception, and the non-primary link cannot be used for data transmission/reception due to the previous configuration of the antennas in the period T3.

After the period T5, after the AP 110 detects that the channel used by the primary link is not busy, the AP 110 may notify the NSTR MLD 120 that both the primary link and the non-primary link can be used for data transmission/reception, and the AP 110 performs the dynamic radio chain switching mechanism to switch the antenna configuration of the primary link and the non-primary link, so that the primary link corresponds to two antennas while the non-primary link corresponds to other two antennas.

In the embodiment shown in FIG. 1 and FIG. 2, because the AP 110 can dynamically switch the antenna configuration of the primary link, the communications between the AP 110 and the NSTR MLD 120 or the station 130 will have better performance.

In addition, because of the dynamic radio chain switching mechanism used by the AP 110, the data transmission/reception of the AP 110 may have phase consistency issue. To solve this problem, the AP 110 is configured to use the uncompressed beamforming report to calibrate the phases of the data/transmission/reception. Specifically, the AP 110 transmits a training signal to the NSTR MLD 120, and the NSTR MLD 120 transmits uncompressed beamforming report to the AP 110 in response to the training signal, wherein the uncompressed beamforming report means that the beamforming report is not processed by a matrix to become a smaller frame (i.e. the uncompressed beamforming report has no distortion), and the AP 110 does not need to decode the received beamforming report for further phase calibration after dynamic radio chain switching.

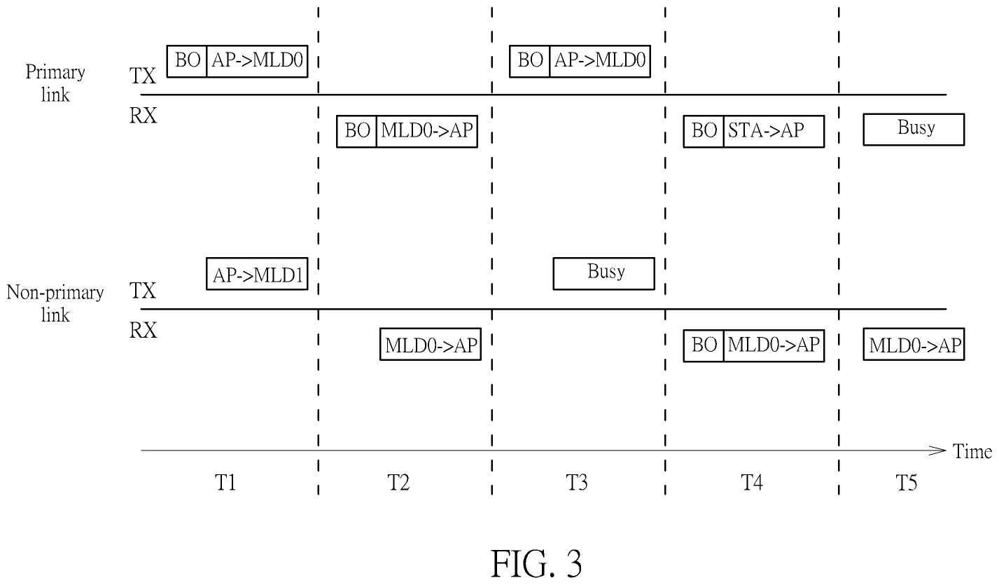

FIG. 3 is a timing diagram of the AP 110 communicating with the STR MLD 140 and the station 130 according to one embodiment of the present invention. Referring to FIG. 1 and FIG. 3 together, initially, the STR MLD 140 establishes a link with the AP 110, wherein there are two links (primary link and non-primary link) between the AP 110 and the STR MLD 140, that is the AP 110 can transmit data to the STR MLD 140 via two links simultaneously, and the AP 110 can receive data from the STR MLD 140 via two links simultaneously. In addition, assuming that the station 130 does not support multi-link communications, the AP 110 communicates with the station 130 via only one link (i.e., primary link). In this embodiment, the primary link is configured to use one channel of the 5 GHz band and the 6 GHz band (e.g., 5.925 GHz-7.125 GHz) and two antennas, and the non-primary link is configured to use another channel of the 5 GHz band and the 6 GHz band and other two antennas.

During a period T1 shown in FIG. 3, after a backoff time (the symbol “BO” in FIG. 2), the AP 110 starts to transmit data to the STR MLD 140 (i.e., the symbol “MLD0” shown in FIG. 3) via the primary link, and starts to the transmit data to another MLD (e.g., the symbol “MLD1” shown in FIG. 3) such as the NSTR MLD 120 via the non-primary link, wherein the start times and end times of the data transmission of the two links are preferred to be aligned.

During a period T2 immediately following the period T1, after a backoff time, the STR MLD 140 starts to transmit data via the primary link and the non-primary link, and the AP 110 receives the data via the two links, wherein the start times and end times of the data reception of the two links are preferred to be aligned.

During a period T3 immediately following the period T2, the AP 110 detects that the channel used by the non-primary link is currently busy, or the AP 110 is notified by another device that the channel used by the non-primary link is currently busy, that is the channel may be occupied by another BSS. At this time, the AP 110 transmits data to the STR MLD 140 by using only the primary link, and the non-primary link is not used for data transmission/reception by the AP 110.

During a period T4 immediately following the period T3, because the station 130 does not support the multi-link transmission, the station 130 transmits data to the AP 110 via the primary link only. At this time, if the channel used by the non-primary link is not busy, the STR MLD 140 can actively use the non-primary link to transmit data to the AP 110 after a backoff time when the STR MLD 140 knows that the AP 110 is receiving data. For example, when the STR MLD 140 receives a notification from the AP 110 or the station 130 to indicate that the station 130 starts to transmit to the AP 110, the STR MLD 140 can immediately use the non-primary link to transmit data to the AP 110.

In addition, because the AP 110 is the NSTR AP that cannot transmit and receive data at the same time via multiple links, the AP 110 will align the end times of data reception of the two links, so as to avoid the data transmission of the STR MLD 140 from interfering with the following data transmission of the AP 110. In addition, the STR MLD 140 may perform the PPDU alignment for the AP 110, wherein the information from L_LENGTH, BSS color, AID (association identity), MAC (media access control) address can be used to for the alignment.

During a period T5 immediately following the period T4, the AP 110 detects that the channel used by the primary link is currently busy, or the AP 110 is notified by another device that the channel used by the primary link is currently busy, that is the channel may be occupied by another BSS. At this time, the primary link is not used for data transmission/reception by the AP 110. In addition, if the channel used by the non-primary link is not busy, the STR MLD 140 can actively use the non-primary link to transmit data to the AP 110 when the STR MLD 140 knows that the channel used by the primary link is currently busy.

In the embodiment shown in FIG. 3, when the primary link is used by the station 130 without multi-link transmission or the channel of the primary link is occupied by another BSS, the STR MLD 140 can actively use the non-primary link to transmit data to the AP 110, to make full use of the bandwidth to improve transmission efficiency.

In an alternative embodiment, the STR MLD 140 in the embodiment shown in FIG. 3 can be replaced by an NSTR MLD, an enhanced multi-link single radio (eMLSR) MLD or an enhanced multi-link multiple radio (eMLMR) MLD.

In an alternative embodiment, FIG. 3 can be modified to use the dynamic radio chain switching mechanism shown in FIG. 2, to further improve performance. For example, in the period T3 shown in FIG. 3, the AP 110 can notify the STR MLD 140 and/or the station 130 that only the primary link is used for data transmission/reception, and the AP 110 handshakes the capacity with the STR MLD 140 and/or the station 130 to perform the dynamic radio chain switching mechanism to switch the antenna configuration of the primary link, so that the primary link corresponds to more antennas for data transmission/reception. In this embodiment, the control circuit 116 can configure the primary link to use three antennas or four antennas, and the non-primary link is not used for data transmission/reception now. In the period T3, because the primary link is configured to use more antennas, the AP 110 can transmit data to the NSTR MLD 120 and/or the station 130 with higher performance.

In an alternative embodiment, during the period T4 shown in FIG. 3, after the AP 110 detects that the channel used by the non-primary link is not busy, the AP 110 notifies the STR MLD 140 that both the primary link and the non-primary link can be used for data transmission/reception, and the AP 110 performs the dynamic radio chain switching mechanism to switch the antenna configuration of the primary link and the non-primary link, so that the primary link corresponds to two antennas while the non-primary link corresponds to other two antennas. Then, the station 130 transmits data to the AP 110 via the primary link, and the STR MLD 140 transmits data to the AP 110 via the non-primary link.

In an alternative embodiment, during the period T5 shown in FIG. 3, the AP 110 can notify the STR MLD 140 that only the non-primary link is used for data transmission/reception, and the AP 110 handshakes the capacity with the STR MLD 140 to perform the dynamic radio chain switching mechanism to switch the antenna configuration of the non-primary link, so that the non-primary link corresponds to more antennas for data transmission/reception. In this embodiment, the control circuit 116 can configure the non-primary link to use three antennas or four antennas, and the primary link is not used for data transmission/reception by the AP 110. In the period T5, because the non-primary link is configured to use more antennas, the STR MLD 140 can transmit data to the AP 110 with higher performance.

Briefly summarized, in the embodiments of the present invention, by using the dynamic radio chain switching mechanism, the primary link or the non-primary link can be configured to correspond to different antennas, to improve the efficiency of the AP. In addition, by controlling the STR MLD to actively transmit data to the AP via the non-primary link when the primary link is used by a station without multi-link transmission or the channel of the primary link is occupied by another device, the bandwidth can be used more efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication method performed by an access point (AP), wherein the AP is a non-simultaneous transmit and receive (NSTR) AP multi-link device (MLD), and the wireless communication method comprises the steps of:
establishing a primary link and an non-primary link with a first MLD;
during a first period, transmitting data to the first MLD or receiving data from the first MLD via the primary link and the non-primary link; and
during a second period following the first period, in response to a channel used by the non-primary link being busy, performing a dynamic radio chain switching mechanism to adjust an antenna configuration of the primary link, and using the primary link to communicate with the first MLD.

2. The wireless communication method of claim 1, wherein the step of performing the dynamic radio chain switching mechanism to adjust the antenna configuration of the primary link comprises:
performing the dynamic radio chain switching mechanism to make the primary link correspond to more antennas for data transmission/reception.

3. The wireless communication method of claim 2, wherein the step of establishing the primary link and the non-primary link with the first MLD comprises:
establishing the primary link with the first MLD by using a first group of antennas; and
establishing the non-primary link with the first MLD by using a second group of antennas, wherein the primary link and the non-primary link have of dynamic switch capability; and
the step of performing the dynamic radio chain switching mechanism to make the primary link correspond to more antennas for data transmission/reception comprises:
performing the dynamic radio chain switching mechanism to make the primary link correspond to the first group of antennas and at least a portion of the second group of antennas for the data transmission/reception.

4. The wireless communication method of claim 2, further comprising:
during a third period following the second period, in response to the channel used by the non-primary link not being busy, performing the dynamic radio chain switching mechanism to adjust the antenna configuration of the primary link, and using the primary link and the non-primary link to communicate with at least one wireless device.

5. The wireless communication method of claim 4, wherein the step of using the primary link and the non-primary link to communicate with the at least one wireless device comprises:
during the third period:
using the primary link to receive data from a station, wherein the station does not support multi-link communications; and
using the non-primary link to receive data from the first MLD.

6. The wireless communication method of claim 4, wherein the first MLD is a simultaneous transmit and receive (STR) MLD, an NSTR MLD, an enhanced multi-link single radio (eMLSR) MLD or an enhanced multi-link multiple radio (eMLMR) MLD.

7. The wireless communication method of claim 4, further comprising:
during a fourth period following the third period, in response to the channel used by the primary link being busy, performing the dynamic radio chain switching mechanism to adjust an antenna configuration of the non-primary link, and using the non-primary link to communicate with the at least one wireless device.

8. The wireless communication method of claim 7, wherein the step of performing the dynamic radio chain switching mechanism to adjust the antenna configuration of the non-primary link comprises:
performing the dynamic radio chain switching mechanism to make the non-primary link correspond to more antennas for data transmission/reception.

9. The wireless communication method of claim 1, wherein the primary link is configured to use one channel of a 5 GHz band and two antennas, and the non-primary link is configured to use another channel of the 5 GHz band or the 6 GHz band and other two antennas.

10. An access point (AP), wherein the AP is a non-simultaneous transmit and receive (NSTR) AP multi-link device (MLD), and the AP comprises:
a receive circuit, configured to receive data from at least one wireless device;
a transmit circuit, configured to transmit data to the at least one wireless device; and
a control circuit, configured to control the receive circuit and the transmit circuit to perform the steps of:
establishing a primary link and an non-primary link with a first MLD;
during a first period, transmitting data to the first MLD or receiving data from the first MLD via the primary link and the non-primary link; and
during a second period following the first period, in response to a channel used by the non-primary link being busy, performing a dynamic radio chain switching mechanism to adjust an antenna configuration of the primary link, and using the primary link to communicate with the first MLD.

11. The AP of claim 10, wherein the step of performing the dynamic radio chain switching mechanism to adjust the antenna configuration of the primary link comprises:
performing the dynamic radio chain switching mechanism to make the primary link correspond to more antennas for data transmission/reception.

12. The AP of claim 11, wherein the step of establishing the primary link and the non-primary link with the first MLD comprises:
establishing the primary link with the first MLD by using a first group of antennas; and
establishing the non-primary link with the first MLD by using a second group of antennas; and
the step of performing the dynamic radio chain switching mechanism to make the primary link correspond to more antennas for data transmission/reception comprises:
performing the dynamic radio chain switching mechanism to make the primary link correspond to the first group of antennas and at least a portion of the second group of antennas for the data transmission/reception.

13. The AP of claim 11, further comprising:
during a third period following the second period, in response to the channel used by the non-primary link not being busy, performing the dynamic radio chain switching mechanism to adjust the antenna configuration of the primary link, and using the primary link and the non-primary link to communicate with at least one wireless device.

14. The AP of claim 13, wherein the step of using the primary link and the non-primary link to communicate with the at least one wireless device comprises:
during the third period:
using the primary link to receive data from a station, wherein the station does not support multi-link communications; and
using the non-primary link to receive data from the first MLD.

15. The AP of claim 13, wherein the first MLD is a simultaneous transmit and receive (STR) MLD.

16. The AP of claim 13, further comprising:
during a fourth period following the third period, in response to the channel used by the primary link being busy, performing the dynamic radio chain switching mechanism to adjust an antenna configuration of the non-primary link, and using the non-primary link to communicate with the at least one wireless device.

17. The AP of claim 16, wherein the step of performing the dynamic radio chain switching mechanism to adjust the antenna configuration of the non-primary link comprises:
performing the dynamic radio chain switching mechanism to make the non-primary link correspond to more antennas for data transmission/reception.

18. The AP of claim 10, wherein the primary link is configured to use one channel of a 5 GHz band and two antennas, and the non-primary link is configured to use another channel of the 5 GHz band and the 6 GHz band and other two antennas.

19. A wireless communication method performed by a multi-link device (MLD), comprising:
establishing a primary link and an non-primary link with an access point (AP);
during a first period, transmitting data to the AP or receiving data from the AP via the primary link and the non-primary link; and
during a second period, in response to the AP being receiving data from a wireless device via only the primary link or a channel used by the primary link being busy, transmitting data to the AP via the non-primary link.

20. The wireless communication method of claim 19, wherein the MLD is a simultaneous transmit and receive (STR) MLD, a non-simultaneous transmit and receive (NSTR) MLD, an NSTR MLD, an enhanced multi-link single radio (eMLSR) MLD or an enhanced multi-link multiple radio (eMLMR) MLD, and the AP is a non-simultaneous transmit and receive (NSTR) AP MLD.
